(19) United States
(12) Patent Application Publication
(10) Pub. No.: US 2004/0058303 A1
(43) Pub. Date: Mar. 25, 2004

(54) Method for teaching dance utilizing aerobics

(76) Inventor: Brian Peskin, Houston, TX (US)

Correspondence Address: JUDIE D. DZIEZAK, WALLENSTEIN AND WAGNER, LTD., 53RD FLOOR, 311 SOUTH WACKER DRIVE, CHICAGO, IL, 60606, US

(21) Appl. No.: 10/254,704

(22) Filed: Sep. 25, 2002

(51) Int. Cl. G09B 9/00

(52) U.S. Cl. 434/250

(57) ABSTRACT

A method of dance instruction utilizing aerobics is provided. The method incorporates dance steps into an aerobics routine, so that by repeating the aerobics routine, the participant can quickly learn the dance steps. A variety of dances may be taught by this method, such as the waltz, salsa, mamba, swing, cha cha, tango, zumba, zambra, and merengue, as examples. The method comprises presenting an aerobics routine having at least one dance set, typically at a pace that allows the participant to perform the aerobics routine either with or after the presentation. The method also includes the participant performing the aerobics routine while obtaining a cardiovascular workout. The aerobics routine has at least one dance and preferably, a number of different dances run sequentially or repeating in any combination. The routine includes at least one aerobics movement between dance sets; e.g., bending at the waist, touching the floor, jumping, lunging, or stretching.

### TECHNICAL FIELD

This invention relates generally to a method for teaching dance, and more particularly, to a method of teaching dance through aerobics.

### BACKGROUND

Many people wishing to obtain the benefit of cardiovascular exercise look to either dance or aerobics.

Although aerobics offers a good cardiovascular workout and exercises a variety of muscles, some people find aerobics classes boring. Also, once the class ends, the student has no skills to share with others outside the class.

“Stair step” classes and “TaeBo” are offered as improvements and something more exciting than conventional aerobics classes; however, some people cannot participate because they lack the requisite balance or stamina or have arthritic conditions that prevent them from doing an inclined step. Through its quick movements of the martial arts, TaeBo provides exercise but has also been implicated as a cause for injury in some people.

Dancing—a form of cardiovascular exercise—is not stressful on the joints. It is particularly suitable for those who are overweight or in what may be considered a marginal physical fitness level. In addition, many people find dance intriguing and wish to learn it because it is fun, a useful skill at social events, and one of the relatively few forms of exercise or activities a couple can enjoy together in an intimate fashion. Learning to dance is not without problems, however. One drawback to learning dance routines is the amount of time needed and the associated expense of numerous lessons to become proficient. Dance classes can be boring by themselves. Further, conventional dance lessons conducted in a teaching environment typically offer no instruction on how to quickly switch from one dance to another, as generally occurs in an actual ballroom/club setting.

Although there may be so-called “dance aerobics,” these classes merely teach isolated dance movements in an aerobics routine without giving the participant a rounded sense of how to employ the isolated movements in a social dance situation. In particular, such classes focus on “disco-style” steps for people to dance by themselves and fail to teach any “transferable” skills that allow the participant to apply the dance steps to dancing with a partner.

Thus, there exists a need for a method of teaching dance that expedites the learning process while providing a cardiovascular workout.

### SUMMARY OF THE INVENTION

A first aspect of the present invention is directed to a method of teaching dance through aerobics comprising: (a) presenting an aerobics routine having at least one dance set and at least one aerobics movement at a rate sufficient to allow a participant to perform the aerobics routine, the dance set having at least three foot steps and at least one arm movement; and (b) performing by a participant the aerobics routine at a pace and with an intensity sufficient for a cardiovascular workout.

In another aspect of the invention, a method is provided for teaching dance comprising: (a) presenting an aerobics routine having at least two dances and doing so with sufficient explanation and at a rate sufficient to allow a participant to perform the aerobics routine, each of the at least two dances including at least three foot steps and at least one arm movement; and (b) performing by the participant the aerobics routine substantially as presented in step (a) at a pace and with an intensity sufficient to attain an increased heart rate suitable for a cardiovascular workout. Step (b), and optionally step (a), is repeated until the individual dance sets of the aerobics routine can be performed readily.

In a further aspect of the invention, a method of teaching dance is provided comprising: (a) presenting an aerobics routine, having at least one dance set and at least one aerobics movement, at a rate sufficient to allow a participant to perform the aerobics routine; and (b) performing the aerobics routine with at least one weight and with sufficient intensity as to increase heart rate for a cardiovascular workout. One embodiment includes positioning the feet for each of dance set on a floor plan having indicia for placement of the feet for the dance sets. The method includes repeating step (b) until at least one of said dance sets can be readily performed.

In yet another aspect, a method of teaching dance is provided. This method includes (a) presenting an aerobics routine comprising at least one dance integrated with at least one aerobics movement; (b) performing the aerobics routine at a pace sufficient to increase the heart rate to a range acceptable for a cardiovascular workout; and (c) repeating at least a portion of the aerobics routine until the at least one dance can be readily performed.

Other aspects of the invention will become apparent when taken in conjunction with the following description and drawings.

### BRIEF DESCRIPTION OF DRAWINGS

FIGS. 1A-1C schematically depict the foot positions of an aerobics routine having three dances taught in accordance with the invention, wherein foot positions shown in FIGS. 1A, 1B, and IC respectively depict foot positions for the swing, the salsa, and the waltz; and

FIG. 2 shows a mat having foot positions for an aerobics routine incorporating the salsa, repeated twice, followed by the waltz, repeated twice.

### DETAILED DESCRIPTION

While this invention is susceptible of embodiments in many different forms, there are described herein in detail preferred embodiments of the invention. The present disclosure is to be considered as an exemplification of the principles of the invention and is not intended to limit the broad aspect of the invention to the embodiments illustrated.

In this application, the term “dance set” means a “set” of the core steps from a dance such as the waltz, rumba, salsa, mamba, swing, jitterbug, fox trot, bolero, cha cha, tango, zumba, the Flamenco dance “zambra,” and merengue, as examples, wherein each dance set has at least three foot steps and at least one arm movement.

The term “dance” refers to the nature of the dance set, e.g., the waltz, salsa, and tango, as examples.

The term dance “step” means a movement of a foot from a first position to a second position.

As an example of what the terms “dance” and “dance set” mean, in an aerobics routine that integrates three dances—the salsa (S), the fox trot (F), and the cha cha (H), as examples—the routine may include seven dance sets wherein the three dances are repeated as S-F-H-S-S-F-F.

Several terms refer to the positioning of the feet; e.g., “move ‘right’” or ‘left’ or ‘back’ or ‘forward.’ These terms mean to move the foot directionally in the direction indicated. For example, “move . . . forward” means to move the foot to the front of the body.

The term “aerobics” refers to an activity requiring an increased amount of oxygen as the intensity and duration of exercise increases.

The terms “participant” and “student” refer to the person who views the aerobics routine as it being presented and performs the aerobics routine.

The present invention provides a method of teaching dance through aerobics. In one aspect of the invention, the method comprises (a) presenting an aerobics routine having at least one dance set, and (b) performing the aerobics routine at a pace and with sufficient intensity as to increase the heart rate to provide a beneficial cardiovascular workout. Each dance set has at least three foot steps and at least one arm movement.

The aerobics routine has no restrictions on the number of dances or dance sets that may be used or the order in which they occur. Generally, the aerobics routine has at least one dance set and more typically, at least two dance sets. Preferably, the aerobics routine has from 1 to 200 dance sets; more preferably from 2 to 50 dance sets; and most preferably, from 2 to 10 dance sets.

Generally, the routine repeats a dance at least once and preferably at least twice in any order. In one embodiment, at least two of the dance sets are of the same dance. For example, in a routine of six dance sets using dances A and B, dances A and B may be repeated as A-A-B-A-B-B. In another embodiment, the dance sets are all of the same dance; for example, in an aerobics routine having 50 dance sets, the same dance is repeated 50 times. In yet another embodiment, the aerobics routine includes any number of different dances; e.g., at least four different dances performed in any sequence, such as A-B-C-A-D-E-B-F.

In the dance sets, each foot step of the at least three foot steps includes moving a foot from a first position to a second position. The moving step is chosen from lifting, kicking, sliding, and tapping, and any other suitable step.

The aerobics routine also incorporates at least one aerobics movement. The aerobics movement includes at least one movement that increases the heart rate or maintains the increased heart rate. Examples of aerobics movements include kicking; lunging; bending at the knees; lunging, bending at the waist; bending at the knees, moving the arms, touching the toes or other parts of the body such as the shoulders, waist, or head; stretching; touching the floor with at least one hand; and jumping. Other aerobics movements may be employed.

The “presenting” step is generally conducted by an instructor or other individual. Preferably, the aerobics routine is presented in a class environment as in an aerobics class, but it is equally suitable for presentation to an individual participant for home use via personal instruction (as by a personal trainer) or via video, as examples. In another embodiment, the presenting step may be conducted via at least one of video, personal instruction, class instruction, and a demonstration; e.g., dance instruction may be taught to an aerobics class using a combination of an instructor and a video of the aerobics routine.

In the presenting step, the aerobics routine is presented with sufficient explanation and at a pace sufficient for the participant or other viewer to watch and follow the routine, particularly the foot steps of the dance sets. Typically, the presenting step includes presenting the at least one dance set, having at least three foot steps, and the at least one arm movement in an exaggerated manner relative to the conventional dance so as to promote a better cardiovascular workout.

Another phase of the method includes performing the aerobics routine. The performing step is typically done by a participant, one interested in getting a cardiovascular workout, one interested in learning dance through aerobics, or other consumer. In the performing step, the individual or participant generally performs the aerobics routine without a partner. The method may, however, be employed so a couple performs the dance sets together.

Typically, the performing step includes performing in the aerobics routine at least the same number of dance sets that were presented. In an alternative embodiment, the routine performed deviates from the routine presented; e.g., although a dance set may be presented only once, it may be performed at least twice.

Generally, the participant performs the dance sets at substantially the same time as they are being presented; however, in alternative embodiments, the participant may perform the dance sets after the presentation. For example, if dance sets A, B, and C are presented, the participant usually performs them in that order and concurrently with the presentation. In another embodiment, after one dance set is presented, that dance set may be performed and then repeated at least once.

The dance sets may be performed in a variety of combinations and any number of repetitions; e.g., A-A-B-B-C-C-C-B-A. Typically, each dance set is repeated at least once, preferably at least twice, and most preferably at least 20 times. For example, in one routine, the performing step may include repeating at least one of the dance sets from 1 to 200 times. Another routine may be structured so each dance set is repeated from 20 to 50 times before the next dance begins; e.g., the fox trot may be repeated from 20 to 50 times and the next dance is the rumba, repeated at least 20 times.

The method includes performing the aerobics routine at a pace and with an intensity sufficient to increase the heart rate as to provide a cardiovascular workout. In one embodiment, the method includes checking the heart rate to ascertain whether the participant's heart rate is within a suitable range associated with a beneficial cardiovascular workout. A number of techniques are available for measuring and monitoring the heart rate. As one skilled in the art generally knows how to calculate the target heart rate and how to monitor the heart rate, further discussion is not provided herein.

In one embodiment, the method includes adjusting the pace of the performing step (b) so the increased heart rate falls within a range conferring a beneficial cardiovascular workout—that range being determined by techniques known to those skilled in the art and known to be beneficial.

As the method may be used to teach both individuals and couples to dance, in the performing step of the method, the individual performs the dance sets of the aerobics routine individually without a partner. Alternatively, when the aerobics routine is presented to a couple, in the performing step, the couple performs the aerobics routine.

The method also includes repeating at least a portion of the aerobics routine that was performed, optionally with the presenting step, until at least one of the dance sets can be readily performed.

In another embodiment, the method includes evaluating the participant's performance of at least one of the aerobics movements and the dance sets performed in step (b) so to improve upon the participant's execution of the dance set and optimize the cardiovascular workout. The evaluating step is typically done by the instructor or a personal trainer.

The dance sets generally include core steps from at least one dance conventionally performed by a couple. Examples of dances that may be included, in any combination, in the aerobics routine are the waltz, salsa, mamba, swing, jitterbug, fox trot, bolero, cha cha, tango, zumba, zambra, and merengue.

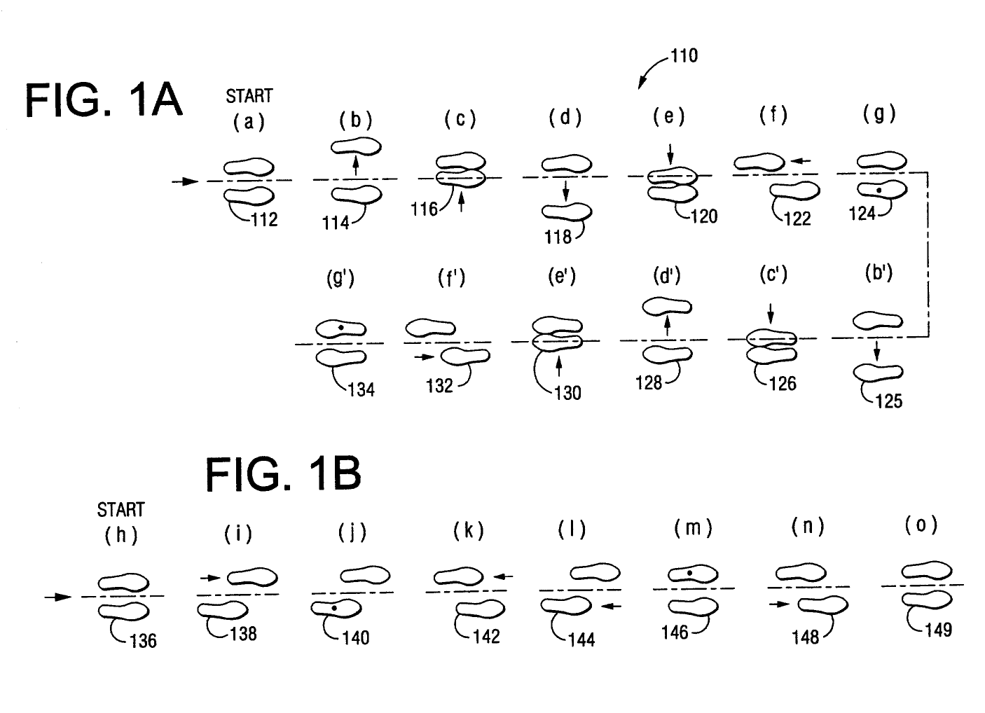

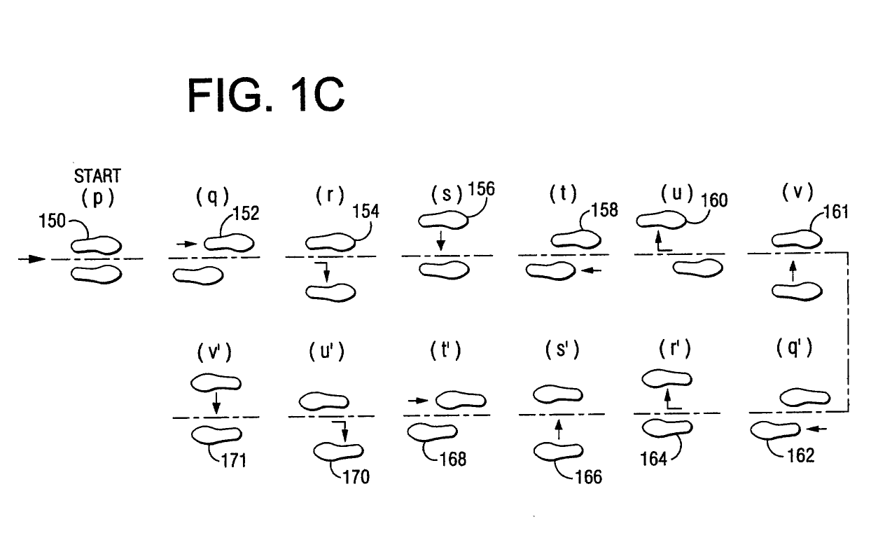

FIGS. 1A-1C collectively show the foot positions of one example of an aerobics routine 110 taught in accordance with the invention. Although the positions of the arms are not shown, the arms are moved throughout the aerobics routine in a manner that provides exercise, consistent with typical aerobics routines. In the example shown, the aerobics routine has five (5) dance sets incorporating three (3) dances conducted one after the other. The dances include variations of, first, the swing, shown in FIG. 1A by foot positions (a)-(g) (represented by reference numbers 112-124); second, the salsa shown in FIG. 1B as foot positions (h)-(o) (represented by reference numbers 136-149); and third, the waltz shown in FIG. 1C by foot positions (p)-(v) (represented by reference numbers 150-160). The present method may be used for any dance, preferably those performed as a couple, and is not restricted to the dances shown in FIG. 1 or discussed herein.

FIG. 1A shows two dance sets of the swing. One dance set has foot positions (a)-(g) (reference numbers 116-124), and the second dance set repeats foot positions (c)-(g), shown by (c′)-(g′) (reference numbers 125-134).

FIG. 1B shows one dance set for the salsa.

FIG. 1C shows two dance sets for the waltz. The first dance set is denoted by foot positions (p)-(v) (reference numbers 150-161); the second dance includes repeating foot positions (q)-(u), which repeated steps are shown as (q′) through (v′) (reference numbers 162-171).

In one embodiment, a pause of at least one 1 second and typically from about 1 to about 8 seconds separates the individual dance sets. In another embodiment, the method includes presenting and performing interim steps between the dance sets, such as at least one aerobics movement that is not part of the preceding or subsequent dance sets. For example, at the end of the swing, the aerobics routine may include kicking the right leg out waist high to the right two times, turning 180 degrees, kicking the left leg out waist high to the left two times, bringing the feet together in a “start” position and then starting a dance set such as the waltz. Additional examples of aerobics movements are discussed above, such as touching the floor or waist and reaching above the head to stretch while holding for a count of three, bending from side to side at the waist, or stretching. These steps may be performed at, e.g., foot positions (b′) (reference number 125) and (o) (reference number 149).

Shown in FIG. 1A, the aerobics routine begins with positioning both feet together, as in foot position (a) (reference number 112). In this step, and throughout the aerobics routine, the arms are positioned and moved in a manner that exercises the muscles and preferably promotes a cardiovascular workout. In FIGS. 1A-1C, movement of a foot up and/or down is denoted by a black dot on the corresponding foot; prime marks denote repeating foot positions.

Shown in FIG. 1A, foot positions for the swing dance set begin at position (a) with both feet together (shown by reference numeral 112), and the left foot moves one step to the left, shown by (b) (reference number 114). Next, the right foot touches the left foot, then moves one step to the right. These foot positions are shown as (c) and (d) (reference numbers 116 and 118), respectively. Next, the left foot touches the right foot, shown by (e) (reference number 120), then moves back one step as shown by (f) (reference number 122). The right foot is lifted and placed down, as shown by (g) (reference number 124). In the embodiment shown, the presenting and performing steps include repeating foot positions (b)-(g), shown by (b′)-(g′), so the first dance set leads directly into the next dance set. The aerobics routine may also include aerobic movements performed between dance sets; e.g., after steps (g) and (g′).

Shown in FIG. 1B are the foot positions for the second dance—the salsa, which is the third dance set. Here, the foot steps are represented by foot positions (h)-(o) (reference numbers 136-149). As noted above, throughout the aerobics routine, the arms are moved so as to provide exercise. The dance begins with the feet positioned together as in foot position (h) (reference number 136). The next step (i) involves moving the left foot forward, as in reference number 138. Next, the right foot is lifted up and placed down in place, as denoted by foot position (j) (reference number 140). The left foot then moves back as in foot position (k) (reference number 142). The right foot is goes back one step, as depicted in step (l) (reference number 144). In position (m) (reference number 146), the left foot is lifted up and set down in place. Then, as depicted in step (n) (reference number 148), the right foot is moved forward to foot position (o) (reference number 149). In the embodiment shown, this dance set is performed once. As discussed above, however, a dance set is usually repeated at least once, preferably repeated at least twice, and more preferably at least 20 times. In the aerobics routine of the method shown in FIG. 1B, the dance set concludes with an optionally set of aerobics movements at position (o) (reference number 149). In the embodiment shown, the salsa dance set leads directly into the third dance, with the feet positioned adjacent each other, as shown by foot position (p) (reference number 150).

Shown in FIG. 1C are the foot positions for the third dance, the waltz. FIG. 1C shows foot positions (p)-(v′) (reference numbers 150-161). This dance set may begin with the feet together as in foot position (p) (reference number 150). The left foot is moved forward as in position (q) (reference number 152). The participant's right foot is moved forward so it is next to the right, then one step to the right as in position (r) (reference number 154). The left foot is moved to the right as in (s) (reference number 156). The right foot then moves one step back as in position (t) (reference number 158). In position (u) (reference number 160), the left foot moves one step back and then one step to the left. In position (v) (reference number 161), the right foot moves toward the left foot. In the embodiment shown, foot positions (q)-(v) (reference numbers 152-161) are repeated as shown by (q′)-(v′) (reference numbers 162-171).

In another embodiment, the performing step is conducted by the participant having at least one weight secured to the body. The at least one weight may be secured to at least one of a foot and an arm of the participant. The at least one weight is generally at least 0.5 pounds. Preferably, the weight ranges from about 0.5 to about 10 pounds and more preferably, from about 0.5 to about 5 pounds, and most preferably, from about 0.5 to about 3 pounds.

The method further comprises checking the heart rate of the participant to ascertain that the performing step is being conducted with sufficient intensity as to achieve a cardiovascular workout and maximize the benefits of the exercise. The performing step is generally performed with sufficient energy and intensity to increase the heart rate to a level known to those skilled in the art as being suitable for providing a beneficial cardiovascular workout.

This invention may be used to teach anyone to dance as a couple, regardless of physical conditioning or age, with particular emphasis on the footwork. This invention allows the participant performing the aerobics routine to adjust the tempo and intensity of the routine, depending upon the degree of aerobic workout desired.

In another aspect of the invention, a method is provided for teaching dance comprising (a) presenting an aerobics routine having at least two dances and doing so with sufficient explanation and at a rate sufficient to allow a participant to perform the aerobics routine, each of said at least two dances including at least three foot steps and at least one arm movement; and (b) performing by the participant the aerobics routine substantially as presented in step (a) at a pace and with an intensity sufficient to attain an increased heart rate suitable for providing a cardiovascular workout. Step (b) and optionally step (a) are repeated until the individual dance sets of the aerobics routine can be readily performed. The dance sets and the presenting and performing steps are substantially as described above.

In another aspect of the invention, a method of teaching dance is provided that uses weights. This method comprises (a) presenting an aerobics routine having at least one dance set and at least one aerobics movement substantially as described above; and (b) performing the aerobics routine with at least one weight and with sufficient intensity as to increase heart rate to provide a cardiovascular workout. The dance sets and the presenting and performing steps are substantially as described above.

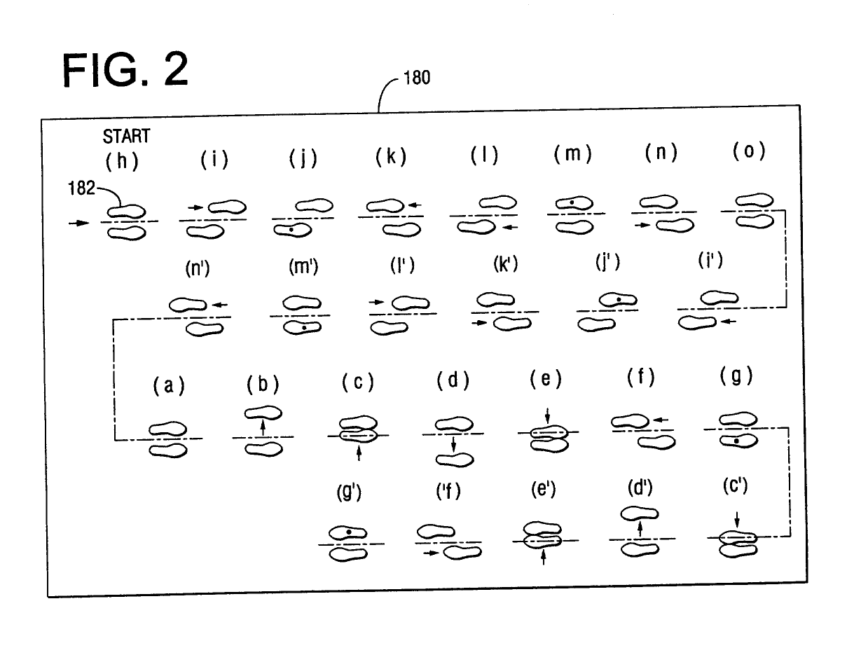

FIG. 2 shows a floor plan 180 that may be used with the method of teaching dance. The floor plan 180 has indicia 182 for guiding the aerobics participant on foot positions for the dances during the aerobics routine. The indicia may be, e.g., painted on a floor or disposed on a mat or rug or other surface.

The floor plan 180 is used in a further aspect of the invention. This method of teaching dance includes (a) presenting an aerobics routine having at least one dance set integrated with at least one aerobics movement at a pace sufficient for a participant to perform the aerobics routine; (b) performing the aerobics routine substantially as described above; and (c) repeating at least a portion of the aerobics routine until the at least one dance can be readily performed. The details set forth above for the dance sets apply to this aspect of the invention.

Each aspect of this invention affords a beneficial cardiovascular workout. Through the use of hand and/or foot weights, attention can be directed to particular arm and leg muscles. Further, because the intensity and pace of the workout can be adjusted to accommodate the participant, the method may be used by people who are physically challenged as well as those with weight problems. Even when utilized to provide the lowest level of an aerobic workout, the method may be used to teach dance. The method is particularly suited for use at home as part of a workout routine, as part of a workout routine with a personal trainer, and in an aerobics class where the combination of dance steps and aerobic exercise may help boost enrollment.

As described above, the aerobics routine may be configured to introduce the participant to a number of dances, where on dance is repeated a predterermined number of times before leading into a different dance set. As a result, the participant becomes comfortable and develops agility in making a transition from one dance to another. This is in contrast to conventional dance classes which typically concentrate on one or two dances with little or no emphasis on changing from one dance to another.

The method also accelerates the rate at which a participant learns to dance because of the high degree of repetition inherent in the aerobics routine. A participant who enrolls in a conventional dance course for couples, after using the method, may find that he or she learns the intricate dances more quickly. Via aerobics, the present invention utilizes repetitive practicing and performing of selected dance sets so that the aerobics participant will be able to build upon the dance sets learned and learn to dance in significantly less time.

Another advantage to the present invention is that it may be one means of attracting men into aerobics-oriented exercise programs, which are oftentimes attended by predominately women. The inventor anticipates that as the focus of the method is on teaching dance—something the participant can engage in outside of class—men are more likely to enroll in and actively participate in such aerobics classes.

It is understood that, given the above description of the embodiments of the invention, various modifications may be made by one skilled in the art. Such modifications are intended to be encompassed by the claims below.

I claim:

1. A method of teaching dance through aerobics comprising:
(a) presenting an aerobics routine having at least one dance set and at least one aerobics movement, the dance set having at least three foot steps and at least one arm movement; and
(b) performing by a participant the aerobics routine at a pace and with an intensity sufficient for a cardiovascular workout.

2. The method of claim 1 wherein each foot step of the at least three foot steps includes moving a foot from a first position to a second position.

3. The method of claim 2 wherein the moving step is chosen from lifting, kicking, sliding, and tapping.

4. The method of claim 1 wherein the at least one dance set includes a dance conventionally performed by a couple.

5. The method of claim 1 wherein the at least one dance set includes a dance chosen from waltz, rumba, salsa, mamba, swing, jitterbug, fox trot, bolero, cha cha, tango, zumba, zambra, and merengue.

6. The method of claim 5 wherein the aerobics movement is conducted between the dance sets of the at least one dance set.

7. The method of claim 1 wherein the at least one aerobics movement includes at least one movement selected from the group consisting of kicking; lunging; bending at the knees; lunging, bending at the waist; bending at the knees, moving the arms, touching the toes or other parts of the body such as the shoulders, waist, or head; stretching; touching the floor with at least one hand; and jumping.

8. The method of claim 1 wherein the aerobics routine includes at least two different dance sets performed in any sequence.

9. The method of claim 1 wherein the performing step comprises repeating at least one dance set of the at least one dance set at least twice.

10. The method of claim 1 wherein the aerobics routine includes from 1 to 200 dance sets.

11. The method of claim 1 wherein the aerobics routine includes from 2 to 50 dance sets.

12. The method of claim 1 wherein the aerobics routine includes at least two dance sets.

13. The method of claim 1 wherein the presenting step includes presenting the at least three foot steps and the at least one arm movement in an exaggerated manner relative to a conventional dance.

14. The method of claim 1 wherein the performing step (b) is conducted with at least one weight secured to the body.

15. The method of claim 1 wherein the performing step (b) is conducted with at least one weight secured to at least one of a foot and an arm.

16. The method of claim 1 wherein the performing step (b) is conducted with at least one weight of at least 0.5 pounds secured to at least one of a foot and an arm of the participant.

17. The method of claim 1 wherein the performing step (b) is conducted with at least one weight ranging from about 0.5 to about 10 pounds secured to at least one of a foot and an arm of the participant.

18. The method of claim 1 further comprising checking the heart rate to determine that the performing step is being conducted with sufficient intensity to achieve a beneficial cardiovascular workout.

19. The method of claim 1 further comprising adjusting the pace of the performing step (b) to attain an increased heart rate within a suitable range for a cardiovascular workout.

20. The method of claim 1 wherein the presenting step is conducted via at least one of video, personal instruction, class instruction, and as a demonstration.

21. The method of claim 1 wherein the performing step is conducted by the participant performing the aerobics routine individually without a partner.

22. The method of claim 1 wherein the presenting step includes presenting the aerobics routine to a couple, and the performing step comprises said couple performing the aerobics routine.

23. The method of claim 1 further comprising repeating at least step (b) until at least one of said dance sets can be readily performed.

24. The method of claim 1 further comprising evaluating the performance of at least one of the dance set and the aerobics movement in step (b).

25. The method of claim 1 wherein the performing step includes performing in the aerobics routine at least the same number of dance sets presented in step (a).

26. A method of teaching dance through aerobics comprising:
(a) presenting an aerobics routine having at least two dance sets and doing so at a rate sufficient to allow a participant to perform the aerobics routine, each of said at least two dance sets including at least three foot steps and at least one arm movement; and
(b) performing by a participant the aerobics routine substantially as presented in step (a) at a pace and with an intensity sufficient to attain an increased heart rate suitable for a cardiovascular workout.

27. The method of claim 26 wherein the at least two dance sets include at least one dance conventionally performed by a couple.

28. The method of claim 26 wherein the at least two dance sets comprise at least one dance chosen from waltz, rumba, salsa, mamba, swing, jitterbug, fox trot, bolero, cha cha, tango, zumba, zambra, and merengue.

29. The method of claim 26 wherein at least two dance sets of the at least two dance sets are of the same dance.

30. The method of claim 26 wherein the performing step (b) includes performing the dance sets as an individual without a partner.

31. The method of claim 26 wherein the performing step (b) includes performing the dance sets as a couple.

32. The method of claim 26 wherein in the performing step (b) includes repeating at least one of the two dance sets from 1 to 200 times.

33. The method of claim 26 wherein the at least two dance sets range in number from 1 to 200.

34. The method of claim 26 further comprising checking the heart rate and adjusting the pace of performing the aerobics routine to attain a cardiovascular workout.

35. A method of teaching dance comprising:
(a) presenting an aerobics routine having at least one dance set and at least one aerobics movement, each said dance set comprising at least three foot steps, said presenting step being performed at a rate sufficient to allow a participant to perform the aerobics routine; and
(b) performing the aerobics routine with at least one weight secured to the body and with sufficient intensity as to increase heart rate to provide a cardiovascular workout.

36. The method of claim 35 wherein step (b) is performed by an individual without a partner.

37. The method of claim 35 further comprising repeating step (b) until at least one of said dance sets can be readily performed.

38. The method of claim 35 wherein step (b) comprises positioning the feet for each of said dance sets on a floor plan having indicia for placement of the feet for said dance sets.

39. A method of teaching dance comprising:
(a) presenting an aerobics routine comprising at least one dance integrated with aerobics movements at a pace sufficient for a participant to perform the aerobics routine, each of said at least one dance having at least three foot steps;
(b) performing the aerobics routine at a pace sufficient to increase the heart rate to a range acceptable for providing a cardiovascular workout; and
(c) repeating at least a portion of the aerobics routine until the at least one dance can be readily performed.
